(19) United States
(12) Patent Application Publication
(10) Pub. No.: US 2025/0331970 A1
(43) Pub. Date: Oct. 30, 2025

(54) DUAL-TANK ORAL IRRIGATOR

(71) Applicant: NINGBO SEAGO ELECTRIC CO., LTD., Ningbo City (CN)

(72) Inventors: Zhimin Liu, Ningbo City (CN); Yanzhong Cai, Ningbo City (CN)

(21) Appl. No.: 19/019,525

(22) Filed: Jan. 14, 2025

(30) Foreign Application Priority Data
Apr. 28, 2024 (CN) 202410520841.9

(51) Int. Cl. A61C 17/02

(52) U.S. Cl. CPC A61C 17/0217

(57) ABSTRACT

The present disclosure provides a dual-tank oral irrigator. The dual-tank oral irrigator includes a press valve, a first water tank, a second water tank, a water-leading pipe, and a pump assembly. The press valve includes an outlet part, a first inlet part, a second inlet part, and a valve core. The valve core can change its position in the press valve by pressing, so as to seal the first inlet part and the second inlet part. The first inlet part is connected to the first water tank, and the second inlet part is connected to the second water tank. One end of the water-leading pipe is connected to the outlet part. The pump assembly is connected to the other end of the water-leading pipe and a spray-out port of the oral irrigator.

### CROSS REFERENCE TO RELATED APPLICATIONS

The present application claims the benefit of Chinese Patent Application No. 2024105208419 filed on Apr. 28, 2024, the contents of which are incorporated herein by reference in their entirety.

### TECHNICAL FIELD

The present disclosure relates to the technical field of oral irrigators, and in particular to a dual-tank oral irrigator.

### BACKGROUND ART

The oral irrigator is an auxiliary for cleaning the oral cavity, which cleans teeth and gaps between teeth by utilizing the pulsed water flow impact. The main effects of the mouthwash (gargle solution) are to clean the oral cavity, and to mask bad breath caused by bacteria or yeast decomposing the food residue, so as to leave a pleasant and refreshing feeling in the oral cavity. The two are complementary in function, and users often utilize mouthwash to rinse their mouths after flushing their teeth with oral irrigators. However, the oral irrigator and mouthwash (usually in bottles) both will take up space, and the portability of travel needs to be improved.

The patent No. CN213130038U discloses a dual-tank oral irrigator, wherein two water tanks and two water pipes are arranged in the oral irrigator, so as to fill different liquids and to meet the requirements of the user. However, the structure is complex, and the water pipe occupies a large space. The switching member controlling outflow of the liquid will cause wear and tear on the water pipe, where there is still room for improvement in stability and durability.

### SUMMARY

In order to solve at least one of the problems mentioned in the background art, the present disclosure provides a dual-tank oral irrigator.

The dual-tank oral irrigator provided by the present disclosure includes:
a press valve, wherein the press valve includes an outlet part, a first inlet part, a second inlet part, and a valve core, and the valve core can change its position in the press valve by pressing, so as to seal the first inlet part or the second inlet part;
a first water tank, wherein the first inlet part is connected to the first water tank;
a second water tank, wherein the second inlet part is connected to the second water tank;
a water-leading pipe, wherein one end of the water-leading pipe is connected to the outlet part; and
a pump assembly, wherein the pump assembly is connected to the other end of the water-leading pipe and a spray-out port of the oral irrigator.

In at least one embodiment, the press valve includes:
a valve body, wherein the valve body includes a main part, with the first inlet part, the second inlet part, and the outlet part extending from the main part; and the outlet part is located between the first inlet part and the second inlet part in an axial direction of the main part; and
a valve core, wherein the valve core is movably arranged in the valve body.

In at least one embodiment, an inner chamber body of the main part includes a main chamber and a first chamber and a second chamber separately arranged on two axial sides of the main chamber, and the main chamber is communicated to the outlet part; the first chamber is communicated to the first inlet part, and the second chamber is communicated to the second inlet part; diameters of the first chamber and the second chamber are both smaller than a diameter of the main chamber; a first axial end surface is formed between the main chamber and the first chamber, and a second axial end surface is formed between the main chamber and the second chamber.

The valve core includes a first sealing part and a second sealing part, wherein the first sealing part can cover the first axial end surface and seal the first chamber, and the second sealing part can cover the second axial end surface and seal the second chamber.

In at least one embodiment, the valve core includes:
a first push rod, wherein the first sealing part radially protrudes from the first push rod; and
a second push rod, wherein the second push rod is connected to the first push rod, and the second sealing part radially protrudes from the second push rod.

In at least one embodiment, the first push rod is slidably arranged in the second push rod. A first spring is arranged between the first push rod and the second push rod in their axial direction, wherein an end part of one end of the second push rod is provided with a second-push-rod snapping part extending toward an inner side of its radial direction, and an end part of one end of the first push rod is provided with a first-push-rod snapping part extending toward an outer side of its radial direction, so that the first spring is pressed when the first push rod and the second push rod move towards each other. After the first push rod and the second push rod move away from each other under the pushing force of the first spring, the first-push-rod snapping part abuts against the second-push-rod snapping part to prevent the first push rod from detaching the second push rod.

In at least one embodiment, a second spring is arranged between the second push rod and the first axial end surface. The press valve further includes a guide rail part, a rotation part, and a push rod part, wherein the rotation part and the push rod part are inserted into the guide rail part, the push rod part extends from the guide rail part, and the rotation part is pressed and abutted against the second push rod. The press valve switches between a pressed-locked state and a pressed pop-up state by pressing the push rod part.

In the pressed-locked state, the first sealing part seals the first inlet part, and the outlet part is communicated to the second inlet part; and in the pressed pop-up state, the second sealing part seals the second inlet part, and the outlet part is communicated to the first inlet part.

In at least one embodiment, the first inlet part and the second inlet part are located at a bottom of the valve body.

In at least one embodiment, the pump assembly includes a pressure chamber, wherein one end of the pressure chamber is connected to the water-leading pipe to lead a liquid in the press valve into the pressure chamber, and a first check valve is arranged between the water-leading pipe and the pressure chamber; and
the other end of the pressure chamber is connected to the spray-out port, so that the liquid in the pressure chamber sprays out of the oral irrigator by the spray-out port, and a second check valve is arranged between the pressure chamber and the spray-out port.

In at least one embodiment, the pump assembly includes:
a gear shaft;
an eccentric bushing, wherein the eccentric bushing is fixedly connected to the gear shaft; and
a transmission rod, wherein one end of the transmission rod is sleeved on the eccentric bushing, the other end of the transmission rod is connected to a separator, and one surface of the pressure chamber is formed by the separator.

In at least one embodiment, the first water tank and the second water tank are separately provided with liquid supply ports.

In the embodiments of the present disclosure, the first water tank can store the flushing water, and a second water tank can store mouthwash. The users can select the liquids by controlling the press valve, for example, they can rinse their mouth by using the mouthwash after flushing their teeth, which is more portable. The present disclosure uses only one water water-leading pipe instead of two water pipes (water-leading pipes) as in the background art, which makes the structure relatively simple and the space allocation more reasonable.

### BRIEF DESCRIPTION OF DRAWINGS

FIG. 1 shows a front view of a dual-tank oral irrigator according to the embodiments of the present disclosure.

FIG. 2 shows a sectional view of a dual-tank oral irrigator according to the embodiments of the present disclosure.

FIG. 3 shows a schematic structure diagram of a pump assembly of a dual-tank oral irrigator according to the embodiments of the present disclosure.

FIG. 4 shows an axonometric diagram of a press valve used for an oral irrigator according to the embodiments of the present disclosure.

FIG. 5 shows a sectional view of a press valve used for an oral irrigator including a first inlet part and a second inlet part according to the embodiments of the present disclosure.

FIG. 6 shows a sectional view of a press valve used for an oral irrigator including an outlet part according to the embodiments of the present disclosure.

FIG. 7 shows a schematic structure diagram of a guide rail part, a rotation part, and a push rod part of a press valve used for an oral irrigator according to the embodiments of the present disclosure.

FIG. 8 shows a sectional view of a dual-tank oral irrigator provided with a press valve according to the embodiments of the present disclosure.

### REFERENCE NUMBERS

100 press valve; 110 outlet part; 120 first inlet part; 130 second inlet part; 140 valve body; 141 main part; 1411 main chamber; 1412 first chamber; 1413 second chamber; 1414 first axial end surface; 1415 second axial end surface; 150 valve core; 151 first sealing part; 152 second sealing part; 153 first push rod; 1531 first-push-rod snapping part; 154 second push rod; 1541 second-push-rod snapping part; 161 first spring; 170 guide rail part; 171 first guide rail; 172 second guide rail; 173 guide-rail transition bevel; 180 rotation part; 181 insertion part; 182 insertion-part transition bevel; 190 push rod part;
210 first water tank; 211 first liquid supply port; 220 second water tank; 221 second liquid supply port;
300 water-leading pipe;
400 pump assembly; 410 pressure chamber; 411 first check valve; 412 second check valve; 420 gear shaft; 421 gear; 430 eccentric bushing; 440 transmission rod; 450 separator; 460 transmission gear;
500 spray-out port; 510 spray member;
610 battery; and 620 motor.

### DETAILED DESCRIPTION OF EMBODIMENTS

The exemplary embodiments of the present disclosure are described below with reference to the drawings. It should be understood that these specific illustrations are intended only to teach those skilled in the art how to implement the present disclosure, and are not intended to exhaust all possible methods of the present disclosure, nor to limit the scope of the present disclosure.

The embodiments of the present disclosure provide a dual-tank oral irrigator. The dual-tank oral irrigator can include a press 100, a first water tank 210, a second water tank 220, a water-leading pipe 300, and a pump assembly 400.

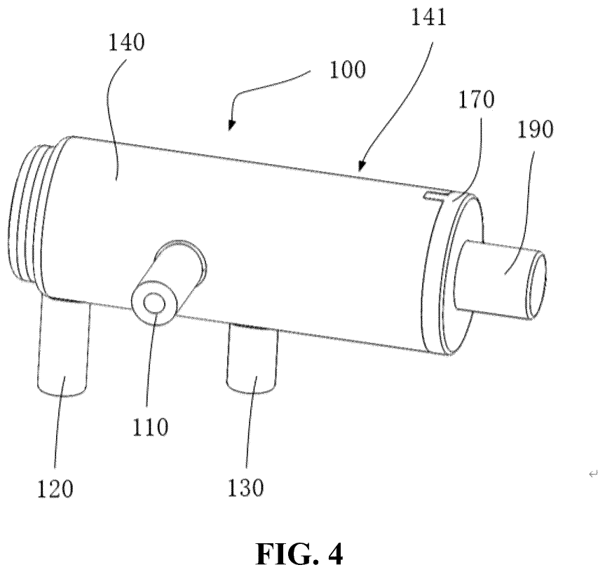

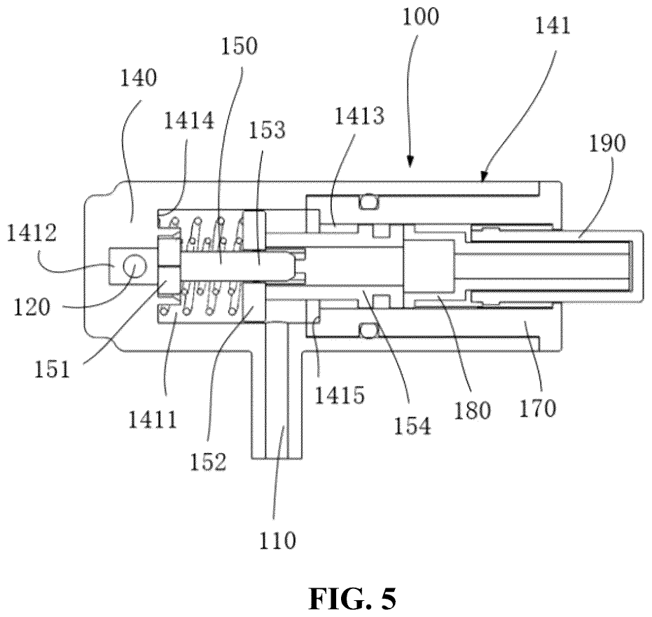

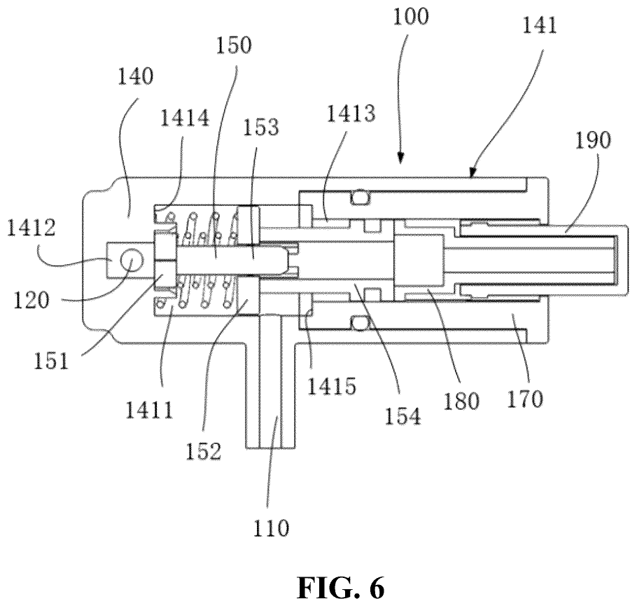

Referring to FIG. 4, FIG. 5, and FIG. 6, the press valve 100 can include an outlet part 110, a first inlet part 120, a second inlet part 130, and a valve core 150, wherein the valve core 150 can change its position in the press valve 100 by pressing, so as to seal the first inlet part 120 or the second inlet part 130.

Further, the press valve 100 can include a valve body 140. The valve body 140 includes a main part 141, with the first inlet part 120, the second inlet part 130, and the outlet part 110 extending from the main part 141. The outlet part 110 is located between the first inlet part 120 and the second inlet part 130 in an axial direction of the main part 141. The valve core 150 can movably arranged in the valve body 140. The outlet part 110 can communicated to one of the first inlet part 120 and the second inlet part 130 by moving the valve core 150, so that the flow direction of the liquid in the valve body 140 can be controlled.

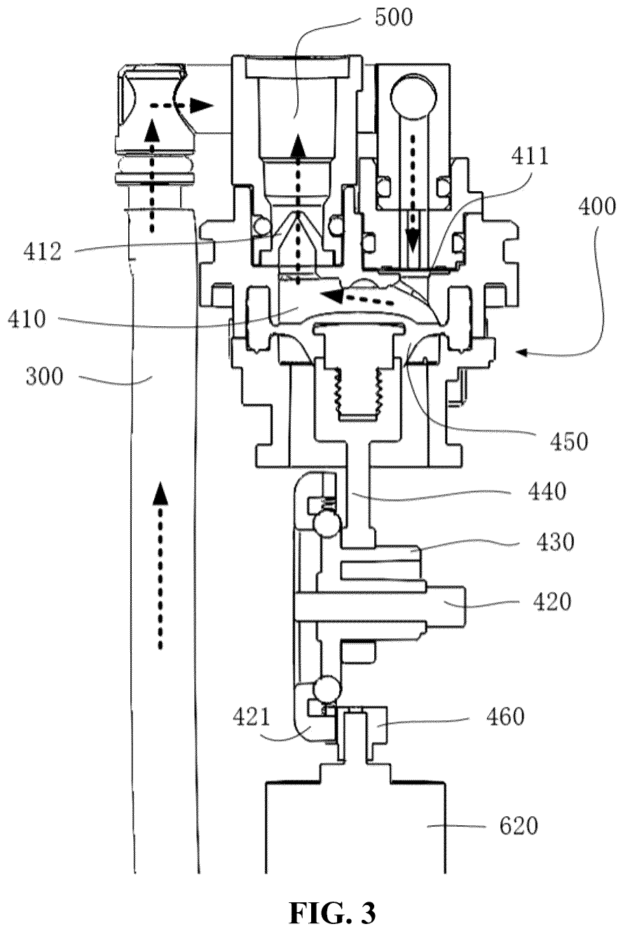

It can be understood that in the present disclosure, the press valve 100 is applied in the oral irrigator, wherein the liquid switching process is simple without abrasion to the water-leading pipe 300 of the dual-tank oral irrigator (referring to FIG. 3, described later), which has a stable and durable structure and a long service life.

In one embodiment of the present disclosure, referring to FIG. 5 and FIG. 6, the inner chamber body of the main part 141 includes a main chamber 1411 and a first chamber 1412 and a second chamber 1413 separately arranged on two axial sides of the main chamber 1411, wherein the main chamber 1411 is communicated to the outlet part 110, the first chamber 1412 is communicated to the first inlet part 120, and the second chamber 1413 is communicated to the second inlet part 130. The diameters of the first chamber 1412 and the second chamber 1413 can both be smaller than the diameter of the main chamber 1411, a first axial end surface 1414 is formed between the main chamber 1411 and the first chamber 1412, and a second axial end surface 1415 is formed between the main chamber 1411 and the second chamber 1413.

The valve core 150 can include a first sealing part 151 and a second sealing part 152, wherein the first sealing part 151 can cover the first axial end surface 1414 and seal the first chamber 1412, and the second sealing part 152 can cover the second axial end surface 1415 and seal the second chamber 1413. Therefore, the first chamber 1412 and the second chamber 1413 can be correspondingly sealed by moving the valve core, so as to control the flow direction of the liquid in the valve body 140.

In one embodiment of the present disclosure, referring to FIG. 5, the valve core 150 includes a first push rod 153 and a second push rod 154, wherein the first sealing part 151 radially protrudes from the first push rod 153, the second push rod 154 is connected to the first push rod 153, and the second sealing part 152 radially protrudes from the second push rod 154. Exemplary, the first sealing part 151 can be a cylindrical structure arranged on an end part of the first push rod 153, and the second sealing part 152 can be a flange structure arranged on an end part of the second push rod 154.

In one embodiment of the present disclosure, referring to FIG. 5, the first push rod 153 is slidably arranged in the second push rod 154. For example, the second push rod 154 is provided with an axial chamber, and the first push rod 153 slides from one end thereof (e.g., the right end of FIG. 5) and extends into an axial chamber of the second push rod 154.

The first spring 161 is arranged between the first push rod 153 and the second push rod 154 in their axial direction, wherein an end port of one end of the second push rod 154 (e.g., the left end in FIG. 5) is provided with a second-push-rod snapping part 1541 extending toward an inner side of its radial direction, and an end part of one end of the first push rod 153 (e.g., the right end in FIG. 5) is provided with a first-push-rod snapping part 1531 extending toward an outer side of its radial direction, so that the first spring 161 is pressed when the first push rod 153 and the second push rod 154 move towards each other. After the first push rod 153 and the second push rod 154 move away from each other under the pushing force of the first spring 161, the first-push-rod snapping part 1531 abuts against the second-push-rod snapping part 1541 to prevent the first push rod 153 from detaching the second push rod 154.

In one embodiment of the present disclosure, referring to FIG. 5, the second spring 162 is arranged between the second push rod 154 and the first axial end surface 1414, for example, the second spring 162 can abut against the first axial end surface 1414 and the second sealing part 152.

The present disclosure can include a press pop-up switching mechanism connected to the valve core 150, so that the station in the press valve can be manually controlled. For example, the press pop-up switching mechanism can be similar to the press pop-up structure of a press ballpoint pen, which can realize two states: press lock and press pop-up, corresponding to two states of the press valve 100 sealing the first inlet part 120 and the second inlet part 130 respectively. The press pop-up switching mechanism of the present disclosure is applied to the valve structure of the oral irrigator, which facilitates manual switching of the flow state of the liquid in the valve and is simple to operate.

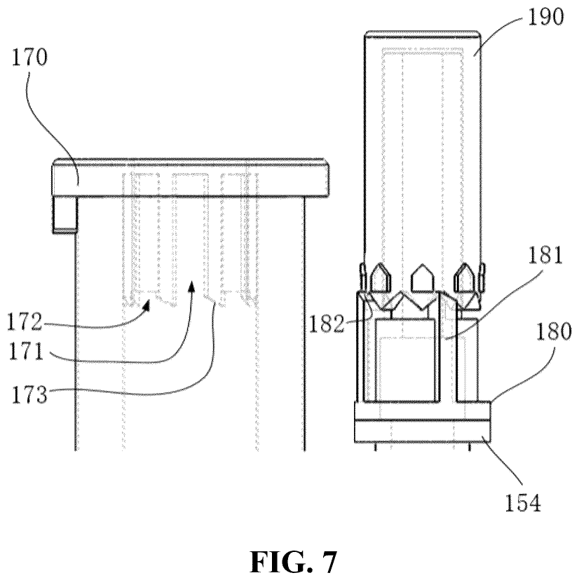

Further, referring to FIG. 7, the press pop-up switching mechanism can further include a guide rail part 170, a rotation part 180, and a push rod part 190.

The guide rail part 170 is fixedly mounted to the valve body 140, and a plurality of first guide rails 171 and a plurality of second guide rails 172, which are alternately arranged around the axis, are arranged on the inner wall surface of the guide rail part 170. The first guide rails 171 are longer than the second guide rails 172, a guide-rail transition bevel 173 is arranged between the first guide rails 171 and the second guide rails 172, and extension directions of the first guide rails 171 and the second guide rails 172 can both be parallel to the axis.

The rotation part 180 is arranged on the inner side of the guide rail part 170, and a plurality of insertion parts 181, which are arranged around the axis, are arranged on the outer wall surface of the rotation part 180. With the rotation of the rotation part 180, the plurality of insertion parts 181 can switch between two states of inserting the plurality of first guide rails 171 and inserting the plurality of second guide rails 172. The insertion-part transition bevel 182 can be arranged on the end part of one end of the insertion part 181, and the other end of the rotation part 180 can abut against the second push rod 154. The insertion depth of the insertion part 181 is changed by the depths of the first guide rail 171 and the second guide rail 172, which in turn affects the axial position of the second push rod 154.

The push rod part 190 can be slidably and non-rotatably arranged on the guide rail part 170. The insertion part 181 can be pushed away from the first guide rail 171 or the second guide rail 172 by pressing the push rod part 190. After the insertion part 181 leaves the guide rail, the non-rotating push rod part 190 presses and abuts against the insertion-part transition bevel 182, and its lateral force rotates the insertion part 181 at a certain angle. After the press is released, the insertion part 181 rebounds under the action of the spring and inserts into the other one of the first guide rail 171 or the second guide rail 172, so as to switch the states. For example, after rotating and switching from the first guide rail 171 to the second guide rail 172 and stabilizing, the insertion part 181 is in a pressed-locked state. The first inlet part 120 is blocked, and the outlet part 110 is communicated to the second inlet part 130, and then, after the push rod part 190 is pressed and released again, the insertion part 181 is rotated and switched from the second guide rail 172 to the first guide rail 171, at which time it is in a pressed pop-up state, wherein the second inlet part 130 is blocked, and the outlet part 110 is communicated to the first inlet part 120.

It can be understood that the left side guide rail part 170 in FIG. 7 should be mounted on the outer side of the rotation part 180 and the push rod part 190 which are at the right side.

The working state of the press valve 100 can be adjusted by manually pressing the push rod part 190, or the push rod part 190 can be driven to move by a power structure such as the motor, so that the working state can be automatically adjusted. The controllers of the power structure such as the motor can be communicated to the application of the mobile terminal, so as to realize the automatic switching of teeth flushing and gargling processes. For example, it can be set to be that in the first 2 minutes, the outlet part 110 is communicated to the first inlet part 120 to flush the teeth with the clean water; and after the flushing duration of 2 minutes is finished, the motor drives the push rod part 190 to move, the outlet part 110 is connected to the second inlet part 130, so as to switch to rinsing with mouthwash. Of course, the activation of its automatic switching function and the specific switching time can be adjusted according to the needs of users.

In one embodiment of the present disclosure, referring to FIG. 5, the first inlet part 120 and the second inlet part 130 are located at the bottom of the valve body 140. The design of which the first inlet part 120 and the second inlet part 130 are both located at the bottom facilitates the mounting of the press valve 100, for example, they can be inserted vertically into the corresponding interface of the water tank, which is simple in structure and easy to mount.

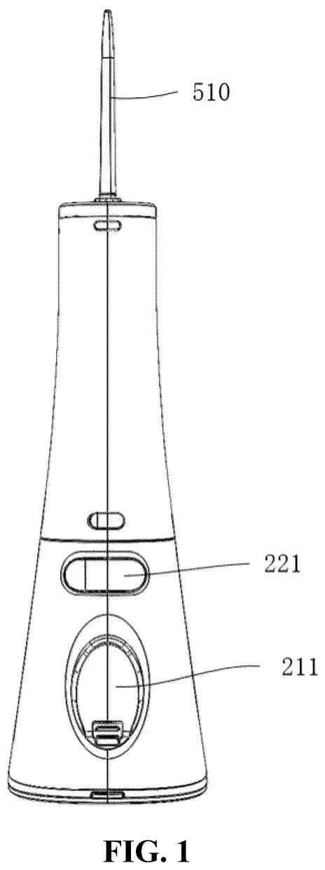

Referring to FIG. 1 to FIG. 3, the dual-tank oral irrigator can include the first water tank 210, the second water tank 220, the water-leading pipe 300, the pump assembly 400, and the foregoing press valve 100 aforementioned, wherein the first inlet part 120 is connected to the first water tank 210, the second inlet part 130 is connected to the second water tank 220, and the outlet part 110 is connected to one end of the water-leading pipe 300.

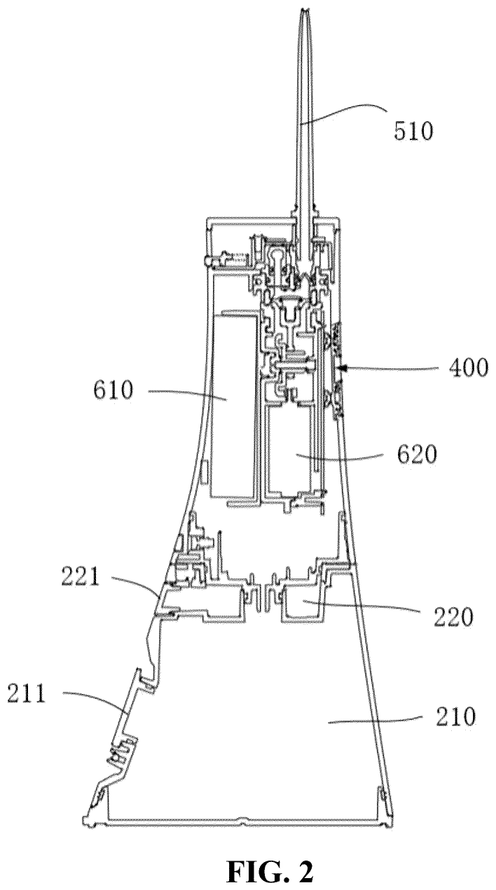

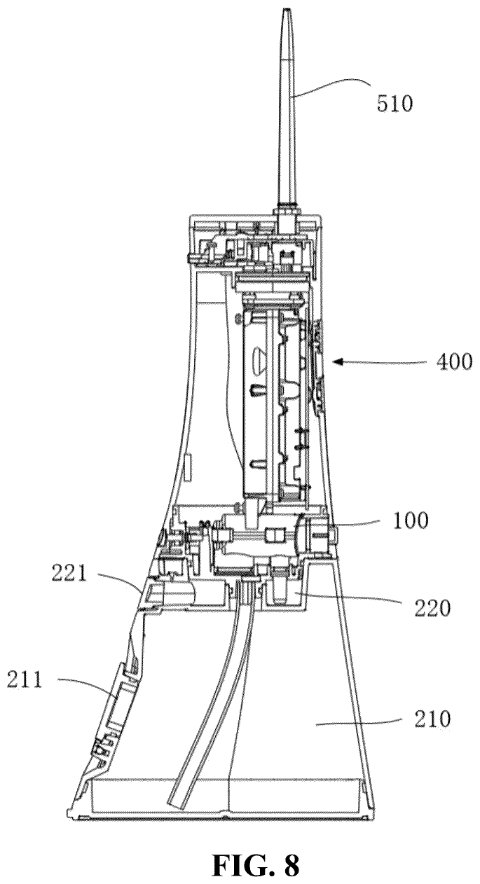

Referring to FIG. 3, the pump assembly 400 can include a pressure chamber 410. One end of the pressure chamber 410 (e.g., the upper right end of the pressure chamber 410 from the view of FIG. 3) is connected to the water-leading pipe 300, and the liquid in the press valve 100 is led into the pressure chamber 410. The other end of the pressure chamber (e.g., the upper left end of the pressure chamber 410 from the view of FIG. 3) is connected to the spray-out port 500, and the liquid in the pressure chamber 410 is sprayed out of the oral irrigator via the spray-out port 500. A spray member 510 can further be arranged outside the spray-out port 500 (referring to FIG. 1, FIG. 2, and FIG. 8). As shown by the dashed arrow in FIG. 3, the liquid in the first water tank 210 or the second water tank 220 can be sprayed out of the spray-out port 500 via the water-leading pipe 300 and the pressure chamber 410.

Optionally, the first water tank 210 can store the flushing water, and the second water tank 220 can store mouthwash, wherein the volume of the first water tank 210 is larger than the volume of the second water tank 220. After flushing teeth, the users can use the oral irrigator to spray mouthwash to rinse their mouth, without the need to carry two separate hygiene products, which is more portable. The present disclosure uses only one water water-leading pipe 300 instead of two water pipes (water-leading pipes) as in the background art, which makes the structure relatively simple and the space allocation more reasonable. The station switching process of the press valve 100 does not wear the water-leading pipe 300, and the oral irrigator is sturdy and durable.

In one embodiment of the present disclosure, referring to FIG. 3, a first check valve 411 is arranged between the water-leading pipe 300 and the pressure chamber 410, and a second check valve 412 is arranged between the pressure chamber 410 and the spray-out port 500. The second check valve 412 can be a duckbill valve.

In one embodiment of the present disclosure, referring to FIG. 2, the dual-tank oral irrigator can include the battery 610 and the motor 620. The battery 610 is connected to the motor 620, and the output shaft of the motor 620 is connected to the pump assembly 400, so that the liquid can be conveyed by pumping.

In one embodiment of the present disclosure, referring to FIG. 3, the pump assembly 400 can include a gear shaft 420, an eccentric bushing 430, and a transmission rod 440. The eccentric bushing 430 is fixedly connected to the gear shaft 420. One end of the transmission rod 440 is sleeved on the eccentric bushing 430, and the other end of the transmission rod is connected to a separator 450. One surface of the pressure chamber 410 is formed by the separator 450. The working principle is as follows. The gear shaft 420, after driven by the motor 620, drives the eccentric bushing 430 to rotate, and the transmission rod 440 and the eccentric bushing 430 form a cam mechanism to drive the transmission rod 440 to reciprocate. When the transmission rod 440 moves upwardly, the liquid in the pressure chamber 410 is pumped out of the spray-out port 500; and when the transmission rod 440 moves downwardly, the liquid in the first water tank 210 or the second water tank 220 is pumped into the pressure chamber 410.

Further, the pump assembly 400 can include a transmission gear 460, and the output shaft of the motor 620 is connected to the transmission gear 460. The transmission gear 460 is engaged with the gear 421 of the gear shaft 420 to drive the gear shaft 420 to rotate. The gears 421 of the transmission gear 460 and the gear shaft 420 can be bevel gears and their axes intersect.

In one embodiment of the present disclosure, referring to FIG. 1, FIG. 2, and FIG. 8, a first liquid supply port 211 is arranged on the side surface of the first water tank 210, and the second liquid supply port 221 is arranged on the side surface of the second water tank 220, wherein the corresponding liquids can be supplied to each water tank respectively by each liquid supply port.

In one embodiment of the present disclosure, referring to FIG. 2 and FIG. 8, the first water tank 210 is located at the lower side of the second water tank 220. The first inlet part 120 and the first water tank 210 can also be connected by a flexible tube, wherein one end of the flexible tube can extend to the bottom of the first water tank 210 so that the oral irrigator extracts the liquid in the first water tank 210.

The foregoing are preferred embodiments of the present disclosure. It should be noted that for a person skilled in the art, several improvements and refinements can be made without departing from the principles of the present disclosure, and these improvements and refinements should also be regarded as the scope of protection of the present disclosure.

1. A dual-tank oral irrigator, comprising
a press valve, wherein the press valve comprises an outlet part, a first inlet part, a second inlet part, and a valve core, and the valve core is capable of changing its position in the press valve by pressing, so as to seal the first inlet part or the second inlet part;
a first water tank, wherein the first inlet part is connected to the first water tank;
a second water tank, wherein the second inlet part is connected to the second water tank;
a water-leading pipe, wherein one end of the water-leading pipe is connected to the outlet part; and
a pump assembly, wherein the pump assembly is connected to another end of the water-leading pipe and a spray-out port of the oral irrigator.

2. The dual-tank oral irrigator according to claim 1, wherein the press valve comprises:
a valve body, wherein the valve body comprises a main part, with the first inlet part, the second inlet part, and the outlet part extending from the main part; and the outlet part is located between the first inlet part and the second inlet part in an axial direction of the main part; and
a valve core, wherein the valve core is movably arranged in the valve body.

3. The dual-tank oral irrigator according to claim 2, wherein an inner chamber body of the main part comprises a main chamber and a first chamber and a second chamber separately arranged on two axial sides of the main chamber, and the main chamber is communicated to the outlet part;
the first chamber is communicated to the first inlet part, and the second chamber is communicated to the second inlet part; diameters of the first chamber and the second chamber are both smaller than a diameter of the main chamber; a first axial end surface is formed between the main chamber and the first chamber, and a second axial end surface is formed between the main chamber and the second chamber; and
the valve core comprises a first sealing part and a second sealing part, wherein the first sealing part is capable of covering the first axial end surface and sealing the first chamber, and the second sealing part is capable of covering the second axial end surface and sealing the second chamber.

4. The dual-tank oral irrigator according to claim 3, wherein the valve core comprises:
a first push rod, wherein the first sealing part radially protrudes from the first push rod; and
a second push rod, wherein the second push rod is connected to the first push rod, and the second sealing part radially protrudes from the second push rod.

5. The dual-tank oral irrigator according to claim 4, wherein the first push rod is slidably arranged in the second push rod, a first spring is arranged between the first push rod and the second push rod in their axial directions, an end part of one end of the second push rod is provided with a second-push-rod snapping part extending toward an inner side of a radial direction of the second push rod, and an end part of one end of the first push rod is provided with a first-push-rod snapping part extending toward an outer side of a radial direction of the first push rod, so that the first spring is pressed when the first push rod and the second push rod move towards each other; and after the first push rod and the second push rod move away from each other under a pushing force of the first spring, the first-push-rod snapping part abuts against the second-push-rod snapping part to prevent the first push rod from detaching the second push rod.

6. The dual-tank oral irrigator according to claim 5, wherein a second spring is arranged between the second push rod and the first axial end surface; the press valve further comprises a guide rail part, a rotation part, and a push rod part, wherein the rotation part and the push rod part are inserted into the guide rail part, the push rod part extends from the guide rail part, the rotation part is pressed and abutted against the second push rod, and the press valve switches between a pressed-locked state and a pressed pop-up state by pressing the push rod part; and
in the pressed-locked state, the first sealing part seals the first inlet part, and the outlet part is communicated to the second inlet part; in the pressed pop-up state, the second sealing part seals the second inlet part; and the outlet part is communicated to the first inlet part.

7. The dual-tank oral irrigator according to claim 2, wherein the first inlet part and the second inlet part are located at a bottom of the valve body.

8. The dual-tank oral irrigator according to claim 1, wherein the pump assembly comprises a pressure chamber, one end of the pressure chamber is connected to the water-leading pipe to lead a liquid in the press valve into the pressure chamber, and a first check valve is arranged between the water-leading pipe and the pressure chamber; and
another end of the pressure chamber is connected to the spray-out port, so that the liquid in the pressure chamber sprays out of the oral irrigator by the spray-out port, and a second check valve is arranged between the pressure chamber and the spray-out port.

9. The dual-tank oral irrigator according to claim 8, wherein the pump assembly comprises:
a gear shaft;
an eccentric bushing, wherein the eccentric bushing is fixedly connected to the gear shaft; and
a transmission rod, wherein one end of the transmission rod is sleeved on the eccentric bushing, another end of the transmission rod is connected to a separator, and a surface of the pressure chamber is formed by the separator.

10. The dual-tank oral irrigator according to claim 1, wherein the first water tank and the second water tank are separately provided with liquid supply ports.
